(19) United States
(12) Patent Application Publication
(10) Pub. No.: US 2026/0044559 A1
(43) Pub. Date: Feb. 12, 2026

(54) Real-Time Multi-Modal Artificial Intelligence Agent

(71) Applicant: GDM Holding LLC, Mountain View, CA (US)

(72) Inventors: Fengning Ding, Jersey City, NJ (US); Dong Yin, Palo Alto, CA (US); Alistair Michael Muldal, London (GB); Neil Charles Rabinowitz, Letchworth Garden City, Hertfordshire (GB); Chen Yan, London (GB); Ankesh Anand, London (GB); Hsiao-Yu Tung, Cupertino, CA (US); Keren Gu-Lemberg, San Francisco, CA (US); Timothy Chieu Nguyen, London (GB); Charles John Deck, London (GB); Arslan Chaudhry, Mountain View, CA (US); Nathaniel John McAleese-Park, San Francisco, CA (US); Pavel Dubov, London (GB); Mikhail Dashevskiy, London (GB); Robert Douglas Fritz, III, Amherst, NH (US); Donald Russell Reed Roberts, London (GB); Lili Janzer, London (GB); Juliette Love, London (GB); Michael Benjamin Chang, San Francisco, CA (US); Nikolai Grigorev, London (GB); Jiaming Li, San Francisco, CA (US); Cédric Hauteville, Woking (GB); Gregory Wayne, London (GB); Keith Anderson, London (GB); Nevena Lazic, San Francisco, CA (US); Arun Ravi Ahuja, Brooklyn, NY (US); Mehdi Abbana Bennani, Paris (FR); Dilan Gorur, San Francisco, CA (US); Duncan David Ross Williams, Malvern, Worcester (GB); Richard James Green, Hertford, Hertfordshire (GB); Toshiyuki Fukuzawa, London (GB); Sridhar Thiagarajan, Mountain View, CA (US); Federico Javier Carnevale, London (GB); Praveen Deepak Srinivasan, London (GB); Tobias Markus Pohlen, London (GB); Sina Samangooei, Histon, Cambridge (GB); Mehdi Mirza Mohammadi, London (GB); Jonas Degrave, London (GB)

(21) Appl. No.: 19/366,240

(22) Filed: Oct. 22, 2025

Related U.S. Application Data
(63) Continuation of application No. PCT/US2025/029012, filed on May 13, 2025.
(60) Provisional application No. 63/646,306, filed on May 13, 2024.
(60) Provisional application No. 63/647,601, filed on May 14, 2024.

(51) Int. Cl. H04N 21/234; G06F 16/435; H04N 21/643

(52) U.S. Cl. CPC H04N 21/234; G06F 16/437; H04N 21/643

(57) ABSTRACT

Provided is a real-time multi-modal artificial intelligence agent. In some implementations, the multi-modal agent can be implemented as a “situated agent”. The term situated agent refers to a setting in which the agent shares one or more perceptual inputs with a human user. For example, the situated agent can receive and process various data inputs, including video, audio, and/or textual data which are also observable by the human user. The agent can process these inputs to generate responses that are contextually-relevant for the user's physical or digital environment, for example enabling the agent to generate dialogue or other responses or outputs which assist the user in understanding and/or navigating the environment.

### PRIORITY CLAIM

The present application is a continuation of International Application Number PCT/US2025/029012 having a filing date of May 13, 2025, which is based on and claims priority to U.S. Provisional Application No. 63/646,306 having a filing date of May 13, 2024 and U.S. Provisional Application No. 63/647,601 having a filing date of May 14, 2024. The present application claims priority to and the benefit of each of such applications and incorporates all such applications herein by reference in their entirety.

### FIELD

The present disclosure relates generally to artificial intelligence systems. More particularly, the present disclosure relates to real-time multi-modal artificial intelligence agents.

### BACKGROUND

An artificial intelligence agent (“agent”) can include a set of computer-executable instructions and/or other computer-readable information that is collectively configured to process inputs to generate outputs. For example, an agent can receive data, apply computational processes to analyze the data according to programmed algorithms or models, and produce results that are determined by the parameters and/or structure of the underlying algorithms or models.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computing system that implements an artificial intelligence agent. The computing system includes one or more computing devices configured to receive and process input data to generate an agent action responsive to the input data. The system includes a tokenization server configured to tokenize the input data to generate a plurality of tokens. The system includes a model server that operates asynchronously with the tokenization server, the model server configured to receive the plurality of tokens from the tokenization server and the process the plurality of tokens with a machine-learned model to generate an output from the machine-learned model, where the agent action is based on the output from the machine-learned model. Other embodiments of this aspect include corresponding computer systems, apparatus, and computer programs recorded on one or more computer storage devices, each configured to perform the actions of the methods.

Implementations may include any combination of one or more of the following features. In some implementations, the input data may include video data and the plurality of tokens may include video tokens. In some implementations, the computing system receives the input data via a real-time communications framework. In some implementations, the real-time communications framework may include a web real-time communication framework. In some implementations, the tokenization server transfers the plurality of tokens to the model server via bidirectional input streaming. In some implementations, the input data may include data corresponding to a plurality of modalities. In some implementations, the tokenization server separately tokenizes the input data for each of the plurality of modalities to generate a plurality of sets of tokens respectively associated with the plurality of modalities. In some implementations, the tokenization server assembles the plurality of sets of tokens into a temporally-ordered token history. In some implementations, the tokenization server streams the temporally-may include token history to the model server. In some implementations, the machine-learned model may include a sequence processing model that has been finetuned on real-world dialogue data. In some implementations, the input data may include a combination of video data and transcribed speech data. For at least one model inference, the output from the machine-learned model may include a null token. In some implementations, the multi-modal agent may include a situated agent, and where at least a portion of the input data may include data descriptive of an environment that is observable by a human user of the situated agent. In some implementations, the output of the machine-learned model may include an event detection output. In some implementations, the computing system implements one or more chain of prompts to perform instruction retrieval, visual extraction, response moderation, and/or state tracking. In some implementations, the computing system implements the artificial intelligence agent with multiple parallel computational threads. In some implementations, the multiple parallel computational threads may include a base response thread and an ad hoc event detection thread, where the computing system initiates the ad hoc event detection thread in response to a user query. In some implementations, the computer system may further include a memory layer that is communicatively coupled to the model server, wherein the memory layer stores data associated with previously-received input data that was received at one or more past times, and wherein data retrieved from the memory layer is provided as contextual input to machine-learned model. In some implementations, the data retrieved from the memory layer comprises object detection data, embedding data, or tokenized input data.

In some implementations, the input data may include augmented visual data. The augmented visual data may include visual data that has been augmented with one or more user annotations or markups. Implementations of the described techniques may include hardware, a method or process, or computer software on a computer-accessible medium. One general aspect includes a computer-implemented method for providing an artificial intelligence agent. The computer-implemented method includes obtaining, by a computing system that may include one or more computing devices, input data. The method also includes tokenizing, by a tokenization server of the computing system, the input data to generate a plurality of tokens. The method also includes streaming, by the tokenization server, the plurality of tokens to a model server of the computing system, the model server operating asynchronously with the tokenization server. The method also includes processing, by the model server, the plurality of tokens with a machine-learned model to generate an output from the machine-learned model. The method also includes performing, by the computing system, an agent action based at least in part on the output from the machine-learned model. Other embodiments of this aspect include corresponding computer systems, apparatus, and computer programs recorded on one or more computer storage devices, each configured to perform the actions of the methods.

Implementations may include any combination of one or more of the following features. In some implementations, obtaining the input data may include receiving the video data via a real-time communications framework, and where the plurality of tokens may include video tokens. In some implementations, streaming, by the tokenization server, the plurality of tokens to the model server may include performing bidirectional input streaming. In some implementations, the input data may include data corresponding to a plurality of modalities. In some implementations, tokenizing, by the tokenization server of the computing system, the input data to generate the plurality of tokens may include separately tokenizing, by the tokenization server, the input data for each of the plurality of modalities to generate a plurality of sets of tokens respectively associated with the plurality of modalities. In some implementations, the method further may include assembling, by the tokenization server, the plurality of sets of tokens into a temporally-ordered token history. In some implementations, streaming, by the tokenization server, the plurality of tokens to the model server may include streaming, by the tokenization server, the temporally-ordered token history to the model server. Implementations of the described techniques may include hardware, a method or process, or computer software on a computer-accessible medium.

### BRIEF DESCRIPTION OF THE DRAWINGS

FIG. 1 illustrates a block diagram of an example artificial intelligence agent according to example implementations of aspects of the present disclosure;

FIG. 2 illustrates a block diagram of an example artificial intelligence agent according to example implementations of aspects of the present disclosure;

FIG. 3 illustrates a block diagram of decoupled tokenization and model execution approach according to example implementations of aspects of the present disclosure;

FIG. 4 illustrates a schematic diagram of an example input processing approach that leverages multiple chain of prompt systems according to example implementations of aspects of the present disclosure;

FIGS. 5-9 illustrate example multi-threaded environments for implementing an artificial intelligence agent according to example implementations of aspects of the present disclosure;

FIG. 10 is a flow chart diagram illustrating an example method for training a machine-learned model according to example implementations of aspects of the present disclosure;

FIG. 11 is a block diagram of an example processing flow for using machine-learned model(s) to process input(s) to generate output(s) according to example implementations of aspects of the present disclosure;

FIG. 12 is a block diagram of an example sequence processing model according to example implementations of aspects of the present disclosure;

FIG. 13 is a block diagram of an example technique for populating an example input sequence for processing by a sequence processing model according to example implementations of aspects of the present disclosure;

FIG. 14 is a block diagram of an example model development platform according to example implementations of aspects of the present disclosure;

FIG. 15 is a block diagram of an example training workflow for training a machine-learned model according to example implementations of aspects of the present disclosure;

FIG. 16 is a block diagram of an inference system for operating one or more machine-learned model(s) to perform inference according to example implementations of aspects of the present disclosure;

FIG. 17 is a block diagram of an example networked computing system according to example implementations of aspects of the present disclosure;

FIG. 18 is a block diagram of an example computing device according to example implementations of aspects of the present disclosure;

FIG. 19 is a block diagram of an example computing device according to example implementations of aspects of the present disclosure;

FIG. 20 is a graphical diagram of an example agent performing event detection according to example implementations of aspects of the present disclosure;

FIG. 21 is a graphical diagram of an example agent processing an input that includes visual data augmented with user input markup according to example implementations of aspects of the present disclosure;

FIG. 22 is a graphical diagram of an example agent performing data processing of visual input comprising visually-rendered computer code according to example implementations of aspects of the present disclosure;

FIG. 23 is a graphical diagram of an example agent performing information retrieval from prior observations according to example implementations of aspects of the present disclosure; and

FIG. 24 is a graphical diagram of an example agent performing problem solving and system optimization according to example implementations of aspects of the present disclosure.

### DETAILED DESCRIPTION

The present disclosure describes computer systems and methods for implementing a real-time multi-modal artificial intelligence agent with improved performance. In some implementations, the multi-modal agent can be implemented as a “situated agent”. The term situated agent refers to a setting in which the agent shares one or more perceptual inputs with a human user. For example, the situated agent can receive and process various data inputs, including video, audio, and/or textual data which are also observable by the human user. The agent can process these inputs to generate responses that are contextually-relevant for the user's physical or digital environment, for example enabling the agent to generate dialogue or other responses or outputs which assist the user in understanding and/or navigating the environment.

The proposed real-time multi-modal agent can incorporate or benefit from a number of different aspects, including: the employment of advanced sequence processing models to enhance dialogue management, the integration of a real-time communication framework to facilitate immediate data exchange, architectural innovations that decouple input tokenization from model deployment, and/or an efficient caching strategy to optimize data flow. Additionally, the present disclosure provides: techniques for event detection, a number of different prompt chaining approaches, and solutions for handling immediate interruptions and delayed responses.

These and other aspects of the present disclosure enhance the real-time responsiveness and contextual accuracy of the multi-modal artificial intelligence agent. In particular, by providing advanced data processing architectures and efficient communication frameworks, aspects of the present disclosure improve system performance in dynamic environments. Specifically, the latency of responses from the agent can be significantly reduced.

According to one aspect of the present disclosure, some example implementations of the proposed real-time multi-modal agent can include or leverage sequence processing models to effectively process and respond to user interactions. For example, these models, such as large-language models (LLMs) and large-multimodal models (LMMs), can process a wide range of input data types, including textual, audio, and/or visual data. By integrating these diverse data types, the agent can generate more contextually relevant responses that are configured to the specific situation and environment of the user.

In some implementations, the sequence processing models included in or used by the agent can be specifically fine-tuned to manage different dialogue settings. This includes both turn-based dialogues, where the interaction follows a structured turn-taking pattern, and open dialogues, where any participant may speak at any time without a predefined turn order. This flexibility allows the agent to adapt to various conversational scenarios, maintaining fluidity and coherence in its interactions regardless of the dialogue structure.

Furthermore, in some implementations, the agent can be trained on realistic or authentic dialogue data to enhance its conversational abilities. This training can involve exposing the models to large volumes of authentic dialogues that capture a wide range of human interactions. Through processing this training data, the parameters of the model can be adjusted to recognize and replicate nuanced conversational behaviors based on statistical patterns identified in the data, such as when to initiate speech, when to withhold speech output, and how to generate contextually appropriate responses. For instance, the model can learn when to remain silent in a conversation via exposure to such data, and this learned behavior can be reproduced by the model outputting NULL tokens during those times.

According to another aspect of the present disclosure, the artificial intelligence agent can include or have access to a memory layer that enables the storage and retrieval of various types of information. This can include past interactions, observations, preferences, and/or environmental data. The agent can utilize this stored information to generate new predictions, outputs, or actions, effectively using historical data to inform and improve its real-time responses and decision-making processes.

Various types of data can be stored in the memory layer to support the agent's operations. Object detections, for example, can include indexed records of objects encountered, complete with metadata like timestamps and location coordinates, which help the agent recognize and recall objects across different sessions. Additionally, embeddings of observed visual or textual content can be stored, providing low-dimensional representations that facilitate rapid data retrieval and recognition tasks. The memory can also hold intermediate model activations and/or raw tokens from the agent's processing activities, allowing the agent to resume or adjust ongoing tasks efficiently and reconstruct input sequences over time.

The agent's memory system can be divided into short-term and long-term components, with the former handling recent interactions and the latter storing more permanent, valuable data such as user preferences and historical interactions. This system can support both structured and unstructured data and can employ advanced indexing and search algorithms to facilitate quick and relevant data retrieval based on various parameters. Contextual memory retrieval mechanisms enhance the agent's responsiveness by retrieving pertinent information based on the current environment or past locations visited by the user.

The integration of a dynamic and robust memory layer within the artificial intelligence agent enhances the utility of the agent. By maintaining a repository of diverse data types, the agent can perform context-aware computing, where the context spans some “history” or prior observations or interactions. This capability enables the agent to deliver accurate and contextually relevant responses based on an understanding of past data and environmental contexts.

Another example aspect of the present disclosure is directed to an approach where the agent receives and processes incoming data through a real-time communication framework. This framework can facilitate the exchange of various types of data, including voice, video, and other digital content, in real-time between the agent and other devices or users. By leveraging such technologies, the agent can process and respond to user inputs in a manner that minimizes delays in data transmission and processing, thereby enhancing the immediacy and relevance of the agent's responses.

One example real-time communication technology that can be utilized in this approach is WebRTC (Web Real-Time Communication). WebRTC is an open-source project that supports real-time communication without the need for additional plugins or native apps, making it highly accessible and efficient. This technology can be particularly beneficial in enabling direct peer-to-peer audio and video communications, which can be used to enable the agent to process real-time perception data such as video data (e.g., generated by a camera) and/or audio inputs (e.g., generated by a microphone).

By employing real-time communication frameworks such as WebRTC, the agent can interact with users in a fluid, natural manner that closely mimics human-to-human interaction. Specifically, by minimizing delays in data transmission and processing, the proposed techniques can enable timely and contextually appropriate interactions.

Another aspect of the present disclosure is directed to an architecture for the agent that decouples the processes of input tokenization from model deployment or serving. In some implementations, this can include using multiple different server devices or clusters, each configured for handling different aspects of data processing and model management. For example, a dedicated tokenization server can handle the initial processing of incoming video streams, converting them into manageable tokens as soon as they are received. A separate model server can then take these tokens and applies machine-learned models to generate responses. The separation of these two processes can enhance the efficiency and responsiveness of the agent.

In particular, in some implementations, a dedicated tokenization server is responsible for the initial processing of incoming data inputs. For example, this server can handle video streams received through a real-time communication framework like WebRTC. As soon as the video data arrives, the tokenization server begins the process of breaking down the video into manageable tokens that can be easily processed by machine learning models. This immediate tokenization can ensure that there is no delay in preparing the data for further processing.

On the other hand, a separate model server can be tasked with the deployment and execution of the machine learning models. This server takes the tokenized data from the tokenization server and applies the machine learning models to perform the necessary computations and generate appropriate responses. By having a dedicated model server, the system ensures that the heavy computational tasks do not interfere with the initial data processing tasks on the tokenization server.

The decoupling of tokenization from model serving offers several advantages. Firstly, it allows both processes to operate independently and/or in parallel, significantly reducing the latency that would otherwise occur if these processes were interdependent. For instance, in traditional setups where tokenization and model serving are coupled, tokenization must often pause until model execution is complete, leading to inefficiencies and delays.

Furthermore, this architectural approach supports the processing of longer video inputs without compromising performance. Since the tokenization server is solely focused on breaking down incoming video streams into tokens, it can handle extended videos more effectively. The model server, receiving well-prepared tokens, can maintain high performance even as the complexity or length of the input increases.

Thus, by decoupling input tokenization from model deployment and serving, the agent's architecture described in the present disclosure not only enhances processing efficiency and reduces response times but also improves the system's capability to handle more extensive and complex data inputs seamlessly.

Another aspect of the present disclosure is directed to an efficient caching approach. In some implementations, the tokenization server can employ advanced streaming techniques to communicate data tokens efficiently to the model server. This can include, for instance, the use of bidirectional input streaming. This method allows for a continuous exchange of data tokens and outputs between the tokenization server and the model server, and/or among other servers involved in the operation of the agent.

The streaming process can be particularly beneficial for handling various types of data inputs simultaneously. For example, video data can be sent to specific processing units or server clusters, where it is processed in real-time. Concurrently, audio data from the same input stream can be directed to speech-to-text services, ensuring that both visual and auditory data are processed simultaneously without delay.

Furthermore, the processed data, whether video or audio, can be assembled into a coherent historical context or timeline. This historical data can then be streamed to the model server, enabling the model server to access a continuous, updated stream of information. This method contrasts with previous approaches where data needed to be explicitly packaged and sent from the tokenizer to the model server, a process that was not only slower but also resource-intensive.

By implementing this streamlined caching and streaming approach, the overall interaction between the servers involved in the agent's operation is significantly enhanced. The reduction in data transfer overhead allows for quicker processing times and less strain on the system's resources. Consequently, this leads to improvements in the efficiency and responsiveness of the agent, enabling it to perform its tasks more effectively and interact with users in a more seamless manner (e.g., with reduced latency).

According to another aspect, the agent described in the present disclosure can perform event detection, which may also be referred to as a “proactive mode.” For example, event detection can be implemented by setting timers to periodically execute the agent's model(s) on newly-received inputs. Additionally or alternatively, event detection can be implemented by establishing dedicated computer threads for continuous event detection. This functionality allows the agent to react promptly to environmental changes without requiring explicit prompts from the user. For example, the agent can recognize visual events and initiate appropriate actions independently, which contrasts with traditional turn-based dialogue systems where the agent responds only after the user has spoken.

One method to implement this proactive capability involves setting timers to periodically execute the model on newly-received inputs. This approach ensures that the agent continuously evaluates the environment and decides if an intervention is necessary based on the latest data. For instance, the agent can be programmed to periodically analyze the latest visual data to detect if there has been a significant change in the visual scene that requires attention, such as someone entering the room or an object being moved.

Additionally or alternatively, proactive event detection can be achieved by establishing dedicated computer thread(s) specifically for this purpose. These threads can operate independently of the main communication processes, constantly analyzing incoming data to detect relevant event(s). This setup allows the agent to handle multiple tasks simultaneously, such as maintaining a dialogue with the user while also monitoring the environment for any significant changes that might require immediate action.

In some implementations, the architecture of the agent includes an event handler that listens for user utterances and immediately dispatches a thread to manage any detected event. This configuration enables the system to quickly process new data inputs and apply event detection algorithms, ensuring timely responses based on the criteria set for event significance.

To provide an example, if the agent determines that a query received from a user includes an event detection instruction, then the agent can periodically execute one or more of its machine learning models on newly-received inputs while querying the model(s) as to whether the particular event is detected. For example, if the agent receives a user query of “tell me when you see something that makes sound”, then the agent could thereafter periodically provide the most recently received image frame(s) to the model alongside the original query or some other prompt that instructs the model to indicate whether any objects in the image frame(s) make noise. For example, when the image frames depict a pair of musical speakers, the model output may then include “I see a speaker, which makes sound.”

Moreover, in some implementations, the proactive mode can also utilize smaller, specialized models dedicated to event detection. These models can be optimized for low-latency data processing, enabling the agent to react swiftly to continuously monitor for events without the computational overhead of larger, more complex systems.

Additional aspects of the present disclosure are directed to various “prompt chaining” approaches which can optionally be incorporated within the agent. These optional prompt chaining approaches enhance the agent's responsiveness and accuracy in various contexts.

As one example, in some implementations, the agent can include an instruction retrieval system that utilizes a database to provide reliable task-following capabilities based on retrieved instructions. For instance, when a user queries about a specific task, the agent can access a pre-defined recipe or set of instructions from an external database, ensuring accurate and executable step-by-step guidance.

Another example is a visual extractor system, which can accurately extract and utilize visual information from the environment. This system can first generate text-based captions from images and then use these captions along with the images to enhance the agent's response accuracy to visual-related queries. This approach helps mitigate errors that might arise from biases introduced by irrelevant information in the data inputs.

According to another example, a state tracker system can be implemented to enhance dialogue and task state tracking, helping the agent understand the user's progress in a task. This system can summarize the user's current state and predict the next required steps, facilitating a more guided and interactive user experience.

As another example, a response moderator system can assist in controlling the agent's dialogue responses. This system can decide whether or not a response is necessary based on the user's input, preventing unnecessary or distracting interactions. This can be particularly useful in scenarios where user utterances do not require direct responses, thus maintaining a focused and relevant interaction.

The present disclosure also provides example techniques that address the issue of immediate interruptions during interactions between the user and the agent. The agent can be designed to handle interruptions effectively by incorporating a stop event mechanism. This mechanism can be activated when the speech-to-text (STT) system detects a new user utterance during the agent's response. Upon activation, the audio playback can be halted, and any ongoing verbal response from the agent can be truncated at the interruption point. To ensure the natural flow of conversation, the text-to-speech (TTS) system can be employed on a per-sentence basis, allowing the intonation and context of the truncated sentence to be preserved accurately. This example approach ensures that the agent can respond appropriately to interruptions, maintaining a conversational and responsive interaction with the user.

Another example aspect of the present disclosure is directed to techniques for handling delayed responses. For example, when user utterances occur more rapidly than the agent can respond, a backlog of queries can accumulate, leading to potential confusion as the agent addresses outdated queries. To mitigate this, each user utterance can be tagged with a unique identifier, and a separate thread can be allocated to handle each incoming utterance. This allows the agent to manage responses more effectively by checking if the identifier of the response matches the identifier of the most recent user utterance. If they match, the response can be delivered to the user; if not, the response can be discarded to prevent the agent from addressing stale queries. This example system ensures that the agent's responses are timely and relevant, enhancing the overall effectiveness of the agent-user communication.

In some implementations, the agent can be adapted to various form factors. For example, the agent can be integrated into Al-enabled glasses, allowing users to receive contextual information directly in their line of sight. Similarly, the agent can be connected to a webcam or receive a screencast, enabling it to interact with users through conventional computing devices. Additionally or alternatively, the agent can be deployed on mobile devices, such as smartphones, which may utilize the device's native sensors like cameras and microphones to gather environmental data. As another example, the agent can be incorporated into augmented reality (AR) or virtual reality (VR) devices, providing a more immersive interaction by blending digital content with the real world or creating a fully virtual environment.

The agent can serve various use cases that involve informing, guiding, teaching, or even playing with the user. In some implementations, the agent can inform users about their immediate surroundings or provide detailed explanations on specific topics, enhancing everyday interactions with contextual intelligence. For example, while navigating an unfamiliar city, the agent can offer historical facts and relevant details about visible landmarks. Additionally, the agent can guide users through complex processes or procedures, such as assembling furniture or preparing recipes, by providing step-by-step instructions configured to the user's pace and progress and accounting for the current state of the user's performance of the task. For example, the agent can provide synchronized visual and verbal instructions tailored to the user's progress. As another example, the agent can teach users the underlying principles of a skill, such as playing a musical instrument, enabling them to generalize this knowledge to new situations independently. As yet another example, the agent can analyze code displayed on a screen, identify problematic areas, and suggest optimizations or bug fixes.

The systems and methods of the present disclosure provide a number of technical effects and benefits. Specifically, aspects of the present disclosure address technical challenges associated with achieving real-time, seamless interaction between an artificial intelligence agent and human users. Traditional systems often struggle with latency issues, data processing inefficiencies, and the inability to handle complex or lengthy multimedia inputs effectively.

To solve these technical problem, the present disclosure introduces several techniques that enhance the agent's ability to interact with users in real-time by minimizing delays and maximizing efficiency in data processing. One example solution include the use of a real-time communication framework, such as WebRTC, which facilitates the direct and immediate exchange of voice, video, and other digital content between the agent and users. This technology enables the agent to receive perceptual inputs in real-time, thereby allowing for more efficient communication with reduced latency.

Furthermore, in some implementations, the architecture of the agent is designed to separate the processes of input tokenization from model deployment or serving. This can be achieved by employing two distinct servers: a tokenization server and a model server. The tokenization server is responsible for the initial processing of incoming data inputs, such as video streams, converting them into manageable tokens as soon as they are received. The model server, on the other hand, handles the deployment and execution of AI models. It receives the tokenized data from the tokenization server and applies the AI models to generate appropriate responses. By separating these tasks, the system ensures that the computationally intensive model processing does not interfere with the initial data processing, thereby reducing overall latency and enhancing responsiveness.

Additional technical benefits are provided by an efficient caching approach. For example, the tokenization server can use advanced streaming techniques, such as bidirectional input streaming, to communicate data tokens efficiently to the model server. This method supports the simultaneous processing of different types of data inputs, such as video and audio, and allows for the data to be assembled into a coherent history or timeline.

Various example implementations are described herein with respect to the accompanying Figures.

### Example Agent Systems and Architectures

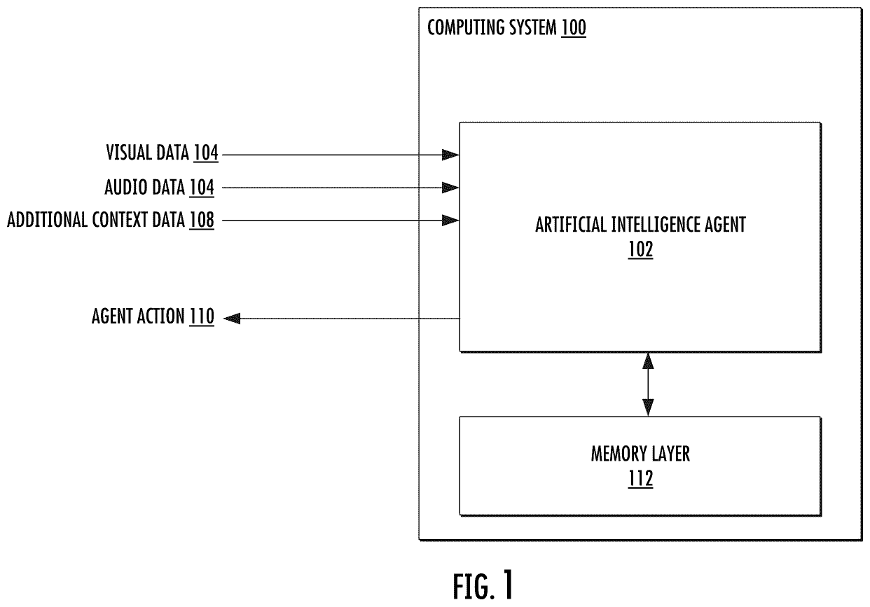

Referring now to FIG. 1, a block diagram illustrates an example computing system 100 configured to implement a real-time multi-modal artificial intelligence agent 102, according to example implementations of aspects of the present disclosure. The depicted computing system 100 is designed to receive multiple types of input data, process this data, and generate outputs that are responsive to the inputs in a contextually appropriate manner.

The artificial intelligence agent 102 within the computing system 100 is configured to receive visual data 104, audio data 106, and additional context data 108. Each type of data is processed by the agent 102 to facilitate interaction within its operational environment. For example, visual data 104 can include live video streams from a camera or recorded video streams from a web resource, while audio data 106 can include spoken commands or ambient sounds captured by microphones.

Additional context data 108 can include sensor data, textual information, or other forms of digital data that provide further insights into the environment or the context of the interaction. As one example, the additional context data 108 can include sensor data that captures user inputs beyond speech inputs, such as touch-screen inputs, gestures, facial expressions, and/or other inputs. These user inputs can, in some implementations, be merged with other inputs such as visual data 104 to create combined inputs. In one example, a user can be provided with an interface that displays a real-time field of view of the agent (e.g., which may correspond to visual data 104). The interface can enable the user to “draw” on or otherwise interact with the interface to mark up the real-time field of view. For example, the user could draw an arrow or make a circle to identify a particular object included within the scene displayed on the interface. The user's graphical input can be added onto or merged with the visual data 104 to form a combined input. For example, the visual data 104 can be amended to include the arrow or circle, which can then be processed by the agent 102. In such manner, interactive interfaces can provide the ability for the user to more granularly interact with or identify portions of the environment when querying the agent 102.

Furthermore, it should be appreciated that in some cases the user will be able to control the type, nature, content, or other characteristics of the visual data 104, audio data 106, and/or additional context data 108. As one example, the user can manipulate a field of view of a camera to alter the content of the visual data 104 that is provided to the agent 102. Similarly, by speaking into a microphone, the user can provide additional audio data 106 as an input for the agent 102. The agent's ability to process and combine visual, auditory, and textual information allows it to generate more comprehensive and nuanced responses, carefully tailored to the user's multi-modal context.

The agent 102 processes these diverse inputs to generate an agent action 110, which can include an output designed to respond to the processed inputs effectively. As examples, this action can range from textual responses, vocal responses, displaying information, controlling connected devices, or any other form of interaction output that is deemed appropriate based on the input data. Specifically, the agent 102 can provide concise answers, generate detailed explanations, offer step-by-step instructions, display information through visual highlights or augmented reality overlays, control connected devices, and/or other forms of actions 110.

In some implementations, the artificial intelligence agent 102 can include and use specialized sequence processing models to integrate and analyze the input data. These models are configured to process complex patterns across different data modalities, enabling the agent 102 to generate more accurate and contextually relevant responses. The sequence processing models may be specifically fine-tuned to handle various interaction dynamics, such as turn-based dialogues or more open-ended conversational formats, enhancing the flexibility and adaptability of the agent.

Furthermore, the computing system 100 can be connected to a real-time communication framework that facilitates the immediate and efficient exchange of data, including the inputs and outputs to and from the agent 102. This configuration reduces latency in data processing and response generation.

In some implementations, the artificial intelligence agent 102 can include or have access to a memory layer 112 or other memory system. As an example, for immediate processing needs, volatile memory such as Random Access Memory (RAM) can be used. As another example, for the purpose of long-term data retention, non-volatile storage solutions such as Hard Disk Drives (HDDs) or Solid-State Drives (SSDs) can be used. Furthermore, the memory layer 112 can include hybrid memory solutions that combine the rapid access capabilities of RAM with the extensive storage capacity of disk storage, thereby optimizing the performance of the agent 102 across various tasks.

The artificial intelligence agent 102 can store and retrieve various types of information to and from the memory layer 112. For example, the artificial intelligence agent 102 can store past interactions, observations, preferences, and/or information from the environment in the memory layer 112. The agent 102 can then recall this information for use in generating new predictions, outputs, or agent actions.

A number of different types of data can be stored in the memory layer 112. One example of data stored within the memory layer 112 can include object detections. This can include indexed records of objects that the agent encounters during its operations, complete with metadata such as timestamps, location coordinates, and/or contextual tags. By archiving these detections, the agent 102 can recognize and recall objects from a “history” of observed scenes. The agent 102 can leverage this information to refine interactions and bolster situational awareness, potentially spanning different sessions of user interaction.

As another example data type, the memory layer 112 can store embeddings of observed visual content, textual content, or other inputs. These embeddings can be low-dimensional numerical representations that encode the essential features of input data into a latent embedding space. The storage of embeddings associated with observed inputs allows the agent 102 to conduct rapid comparisons and recognition tasks efficiently. In particular, these embeddings, which can be derived from various layer(s) of the agent's machine-learned models, can be used to perform similarity searches to facilitate quick data retrieval.

As another example, intermediate model activations can be stored in the memory layer 112. Capturing and preserving the state of model activations at various stages can enable the agent 102 to efficiently resume or adjust its processing activities as needed. This feature can be used in scenarios involving long-running or complex processing tasks that may be interrupted or require dynamic adjustments such as resetting the agent to a prior state associated with a prior time.

As another example, the memory layer 112 can store raw tokens generated by the agent's natural language processing, image processing, or other tokenization mechanisms. For example, a cache of tokens can be stored, with each being associated with a specific timestamp. This data allows for the reconstruction of the sequence of inputs and internal states over time, which can be used to retrieve and replay perceptual inputs associated with a particular timestamp or setting, or to otherwise provide the raw tokens as a contextual input for a later prediction.

By maintaining a repository of these data types, the artificial intelligence agent 102 can be equipped with a knowledge base that supports advanced functionalities such as context-aware computing, personalized interactions, and information retrieval from past observations. For example, upon retrieving stored information from the memory layer 112, the agent 102 can integrate the retrieved data into the current processing workflow. This integration can include aligning historical and current data to enhance the accuracy and relevance of the output.

In some implementations, the agent 102 can include or have access to both short-term and long-term memory components. The short-term memory may be volatile, designed for the temporary storage of recent interactions and sensory inputs. In contrast, the long-term memory may be non-volatile, storing valuable learned information, user preferences, historical interaction data, and significant environmental events for longer-term recall and usage. In addition, the design of the memory layer 112 can accommodate both structured and unstructured data.

In some implementations, the memory layer 112 can be or include some or all of a context window of one or more machine learning models included in the agent 102. For example, the memory layer 112 can store a video that is loaded into the context window of a multi-modal machine-learned model included in the agent 102. The context window can be input into and processed by the machine-learned model to generate a model output from the machine-learned model.

In some implementations, the agent 102 can employ contextual memory retrieval mechanisms. These mechanisms can include analyzing the current context or environment to determine the most relevant information to retrieve from memory layer 112. For instance, recognizing that the user is in a previously-visited location may trigger the retrieval of relevant past interactions or preferences specific to that location.

In some implementations, the agent utilizes indexing and search algorithms to categorize memory based on various parameters such as date, location, interaction type, and content relevance. This structured approach enables quick searches and retrieval of pertinent information without delays. The agent's memory management can be dynamic, with continuous updates of new information and/or periodic deletion of outdated or irrelevant data to optimize memory usage and performance.

The ability of the agent 102 to store information to and retrieve information from the memory layer 112 enables a more sophisticated and personalized user experience. The memory layer 112 enables the agent 102 to provide contextually-relevant responses based on historical data and interactions, enhancing user engagement and satisfaction.

To provide an example application of the proposed memory capabilities, a user can ask the agent 102 to recall the location of an object that was previously within the agent's field of view. The agent 102 can identify the location of the object, referencing its position relative to other objects in the scene. Thus, the agent 102 can store and retrieve a history of visual observations and utilize this information to answer user queries.

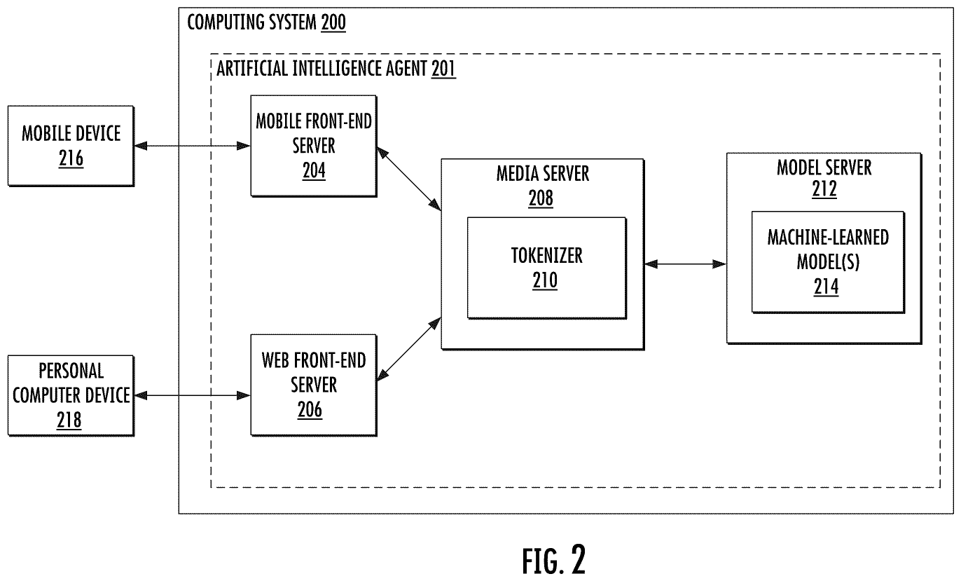

Referring now to FIG. 2, a block diagram illustrates an example computing system 200 configured to implement a real-time multi-modal artificial intelligence agent 201, according to example implementations of aspects of the present disclosure.

The artificial intelligence agent 201, which is implemented by the computing system 200, can be configured to interface with different types of client devices, including mobile device 216 and personal computer device 218. These devices can send and receive data to and from the agent 201, allowing for a dynamic interaction between the user and the agent.

The computing system 200 includes several components that facilitate the operation of the artificial intelligence agent 201. The mobile front-end server 204 and the web front-end server 206 represent the interfaces through which mobile and web-based interactions respectively occur. These servers manage the initial reception of input data from the mobile device 216 and the personal computer device 218, preprocessing this data as necessary before forwarding it to the media server 208.

The media server 208 can act as a central hub within the architecture, receiving processed inputs from both the mobile front-end server 204 and the web front-end server 206. One of the functions of the media server 208 can be to manage the flow of multimedia data, such as video and audio streams, which serve as inputs for the multi-modal capabilities of the agent 201.

The media server 208 can include a tokenizer 210. The tokenizer 210 can operate to process the incoming multimedia data. For example, the tokenizer 210 breaks down complex data streams into manageable tokens, which are simpler data units that can be more easily processed by machine learning models.

From the media server 208, these tokens are then transmitted to the model server 212, which includes and runs one or more machine-learned models 214. These models 214 are responsible for analyzing the tokens to generate responses that are contextually-appropriate based on the input data. The model server 212 operates asynchronously with the tokenizer 210, ensuring that the tokenization process does not delay the response generation, thus maintaining low latency and high responsiveness of the agent 201. Stated differently, the timing of the operations of the tokenizer 210 and the model server 212 can in general be established with less interdependence than if the operations of the tokenizer 210 and the model server 212 were sequentially performed by the same machine or machine cluster.

The architecture illustrated in FIG. 2 supports the efficient processing of data by decoupling the roles of front-end processing and model execution. This decoupling allows the system to optimize performance by parallelizing tasks and minimizing the processing time from input reception to response generation. The use of separate servers for handling different aspects of the data flow—front-end interaction, media processing, and model inference—enhances the system's ability to scale and manage large volumes of interactions simultaneously.

Furthermore, in some implementations, the mobile front-end server 204 and the web front-end server 206 can be specifically configured to support WebRTC protocols or other real-time communication frameworks. This configuration allows these servers to establish peer-to-peer connections with the client devices, facilitating direct data transfer paths that bypass traditional server relay methods. By using WebRTC, the system minimizes the latency typically associated with data transmission over the internet, enhancing the responsiveness of the agent 201.

Additionally, the media server 208 can be equipped with specialized software components that handle the WebRTC streams. These components can include signal processing units that manage the real-time encoding and decoding of video and audio streams, ensuring that the data remains synchronized and maintains high quality throughout the transmission process. The integration of these components allows the media server 208 to efficiently manage the flow of multimedia data, preparing it for further processing by the tokenizer 210 and eventually the model server 212.

In the architecture illustrated in FIG. 2, the term “server” encompasses a broad range of configurations, each potentially comprising one or more machines. This includes setups where a server may represent a cluster of machines working collectively to handle specific tasks or workloads. Additionally, the machines involved in such configurations can be either physical machines, consisting of tangible hardware components, or virtual machines, which operate within a controlled software environment on a physical server.

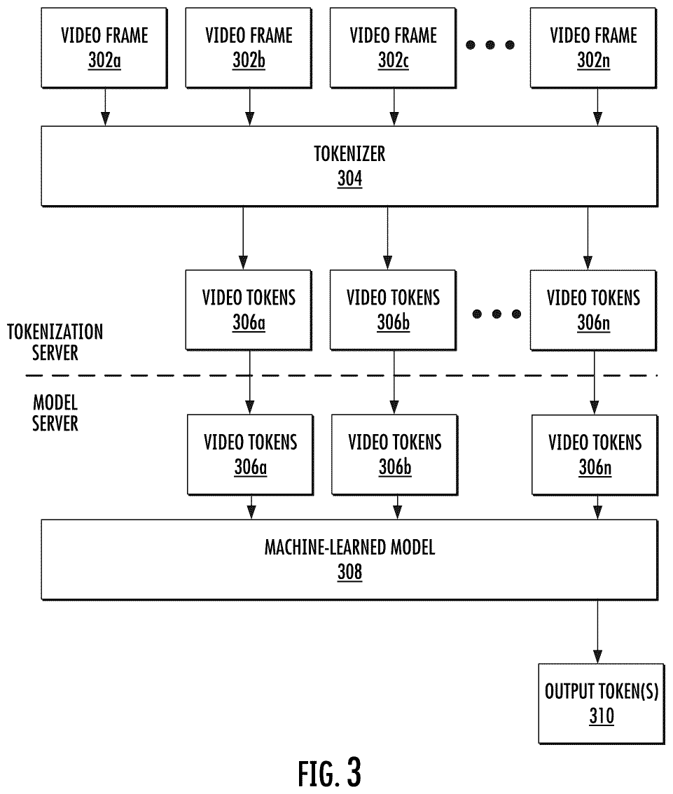

Referring now to FIG. 3, a block diagram illustrates the decoupled tokenization and model execution approach, according to example implementations of aspects of the present disclosure. This diagram illustrates the structured flow of data processing from the initial reception of video frames to the generation of output tokens by the machine-learned model.

The process begins with multiple video frames, labeled as video frame 302a, video frame 302b, video frame 302c, . . . , through video frame 302n. These frames represent a sequence of visual data captured over time, which may be sourced from cameras or other digital video capturing devices or from recorded video media. Each video frame undergoes processing by a tokenizer 304, which is responsible for converting the complex video data into a more manageable form known as video tokens.

These video tokens, depicted as video tokens 306a, video tokens 306b, video tokens 306n, and so forth, represent a tokenized version of the original video frames. The types of tokens generated can vary significantly depending on the specific requirements and configurations of the system.

One possible type of token is an image patch token. In this approach, each video frame is divided into smaller, fixed-size patches. These patches are then individually tokenized, preserving spatial information while reducing the overall complexity of the data.

Another advanced token type is embeddings produced by a machine-learned encoder. In particular, in some implementations, the tokenizer 304 can include a pre-trained neural network or other learned encoder that processes each video frame or patches thereof to produce a dense vector representation, or embedding. These embeddings can then serve as the tokens that are output from the tokenizer 304. These embeddings can capture high-level features of the visual data, such as textures, shapes, and possibly semantic information, depending on the training data and model architecture used.

The operations performed by the tokenizer 304 can range from simple linear projections to more complex non-linear functions. Linear projection involves mapping the high-dimensional video data into a lower-dimensional space using a linear transformation. Non-linear tokenization functions, such as those implemented using neural networks with activation functions like ReLU or sigmoid, allow for a more nuanced transformation of the video data.

The configuration of the tokenizer 304 can be adjusted based on the specific needs of the application. For instance, in scenarios where real-time processing is critical, the tokenizer might be optimized for speed, potentially at the expense of some detail or accuracy. Conversely, in applications where precision is preferred, the tokenizer might employ more sophisticated, computationally intensive techniques to ensure the highest quality tokens.

Once tokenized, the video tokens are forwarded to a model server, which houses the machine-learned model 308. The model server runs the machine-learned model 308 to process the video tokens to generate output token(s) 310. These output tokens represent the actionable data or decisions derived from the video tokens' analysis. They can be used to trigger responses or actions in the system that uses the artificial intelligence agent, such as sending alerts, initiating communication with the user, or adjusting the operation of connected systems based on the content observed in the video frames.

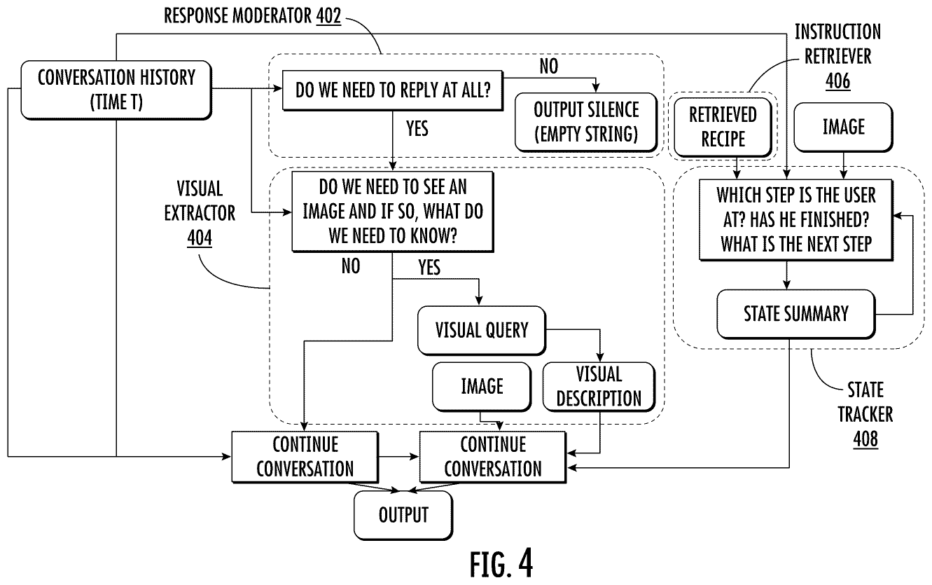

Referring now to FIG. 4, a schematic diagram illustrates an example input processing approach that leverages multiple chain-of-prompt-based systems according to example implementations of aspects of the present disclosure. This diagram presents a detailed view of one example decision-making process within a real-time multi-modal artificial intelligence agent, demonstrating how various components interact to process and respond to multi-modal input data effectively.

FIG. 4 illustrates a response moderator 402, which serves as the initial decision point in the processing flow. The response moderator 402 evaluates the conversation history at a given time (time t) to determine whether a response from the agent is necessary. If the moderator decides that no reply is needed, it outputs silence, represented by an empty string, thereby avoiding unnecessary or distracting interactions. In some implementations the response moderator 402 can be implemented by prompting a sequence processing model.

If a response is deemed necessary, the system then evaluates whether visual information is required to formulate the response. This decision can be facilitated by the visual extractor 404, which can generate visual queries based on the current context of the conversation. If visual data is needed, the visual extractor 404 processes the image (e.g., as prompted by or to respond to the visual query) to provide a visual description, which is then integrated into the ongoing conversation to enhance the response's relevance and accuracy. In some implementations, the query generation and visual description generation steps of the visual extractor 404 can be performed by a sequence processing model.

Simultaneously, the system may also engage the instruction retriever 406, which is responsible for fetching task-specific information such as recipes or instructions from an external data source or database. This component can enable the agent to provide detailed, step-by-step guidance based on reliable and executable information.

The retrieved recipe or instruction set is then evaluated by the state tracker 408, which assesses the user's progress in the task. The state tracker 408 can provide a state summary that includes information about the current step the user is at, whether the step has been completed, and/or what the next step should be. In some implementations, the state tracker 408 can be implemented by periodically querying a sequence processing model with updated visual data and/or conversation history and asking the sequence processing model to maintain or update a current state.

This structured approach allows the artificial intelligence agent to manage complex interactions that require integration of text, visual data, and task-specific instructions. By determining the necessity of each type of input and processing them accordingly, the agent can maintain a fluid and contextually appropriate dialogue with the user.

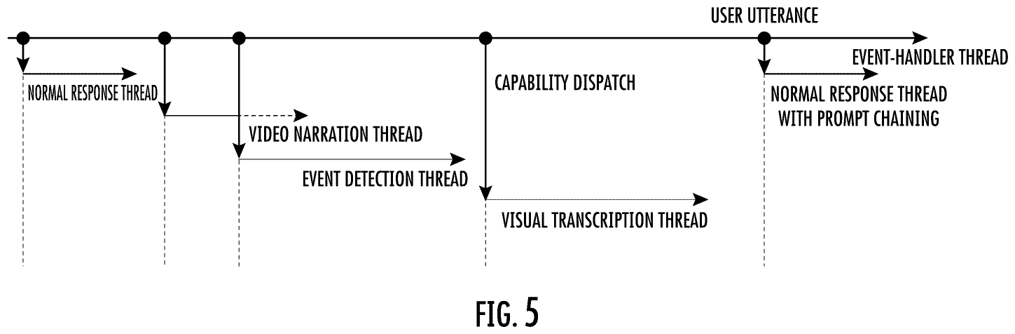

Referring now to FIG. 5, a schematic diagram illustrates an example multi-threaded environment for implementing an artificial intelligence agent, according to example implementations of aspects of the present disclosure. In the illustrated environment, multiple threads are deployed, with each thread configured to handle specific types of tasks or data processing needs.

The diagram depicts several example threads: a normal or base response thread, a video narration thread, an event detection thread, a visual transcription thread, and an event-handler thread, each connected through dispatch mechanisms that determine the flow of operations based on the context of the interaction and the specific needs at that moment.

Normal Response Thread: This thread manages standard interactions with the user, processing inputs such as queries or commands and generating appropriate responses. The thread can operate independently or in conjunction with other threads to ensure that the user receives timely and contextually relevant information.

Video Narration Thread: This thread is activated when there is a need to narrate or describe video content being analyzed by the agent. This thread can be particularly useful in scenarios where visual content is requested to be explained or discussed with the user.

Event Detection Thread: This thread can perform proactive event detection within the agent's operational environment. It can continuously monitor input data streams for specific events or changes that require immediate attention or action. This thread enables the agent to initiate responses or alerts autonomously, without waiting for a direct user prompt.

Visual Transcription Thread: This thread handles the transcription of visual data into a textual or descriptive format that can be easily integrated into the agent's responses.

Event-Handler Thread: The event-handler thread manages the integration of responses generated by other threads into a coherent output that is presented to the user. This thread can ensure that all responses, whether generated from standard interactions, video narration, or event detection, are synchronized and delivered in a manner that maintains the flow and context of the ongoing interaction.

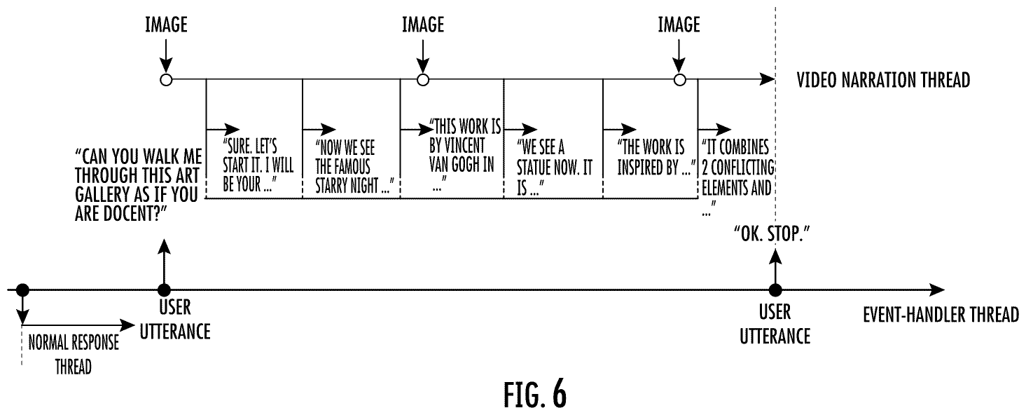

Referring now to FIG. 6, a schematic diagram illustrates an example interaction flow within a real-time multi-modal artificial intelligence agent, according to example implementations of aspects of the present disclosure. The interaction begins with a user utterance, as indicated by the user utterance node at the bottom left of the diagram. In the illustrated example, the user asks the artificial intelligence agent to guide them through an art gallery, querying the quality of the artworks displayed.

As the interaction progresses, the diagram shows several instances where the agent processes images of the artworks, represented by the nodes along the top of the diagram. The descriptions provided by the agent are facilitated by the video narration thread. This thread can handle multimedia content, particularly visual data, enabling the agent to deliver descriptive narratives about each artwork.

The interaction flow also illustrates the agent's capability to handle interruptions, as shown by the user's command “Ok, Stop.” This utterance triggers the event-handler thread to manage ad-hoc events or commands from the user, allowing the agent to respond appropriately to direct inputs that may require the agent to cease its current activity or change its response strategy.

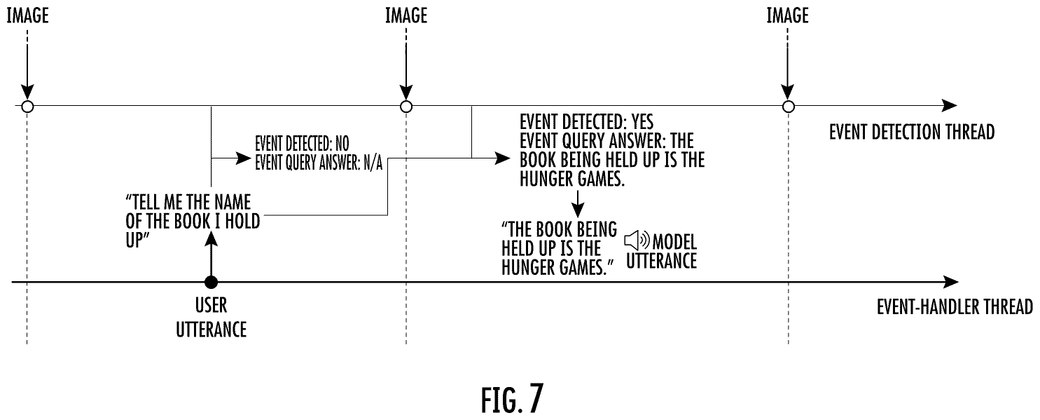

Referring now to FIG. 7, a schematic diagram illustrates an example interaction flow within a real-time multi-modal artificial intelligence agent. This diagram specifically highlights the interaction between the event detection thread and the event-handler thread.

In the illustrated example, the interaction begins with a user utterance, as indicated by the user utterance node at the bottom left of the diagram. The user asks the artificial intelligence agent, “Tell me the name of the book I hold up.” This initiates the event detection thread, which continuously monitors the visual data streams for specific events or changes that require immediate attention or action.

The diagram shows three instances where images are processed, represented by the nodes along the top of the diagram. Each image node can correspond to one or more specific frames captured by the system's visual sensors, which the agent analyzes to detect any relevant events. The first image does not trigger any event detection response, as indicated by the event detection thread's output “Event detected: No, Event query answer: N/A.” However, the second image results in a positive event detection, as the agent successfully identifies the book being held up by the user.

In some implementations, upon detecting this event, the event-handler thread is activated. For example, the agent then generates a model utterance that provides the user with the requested information.

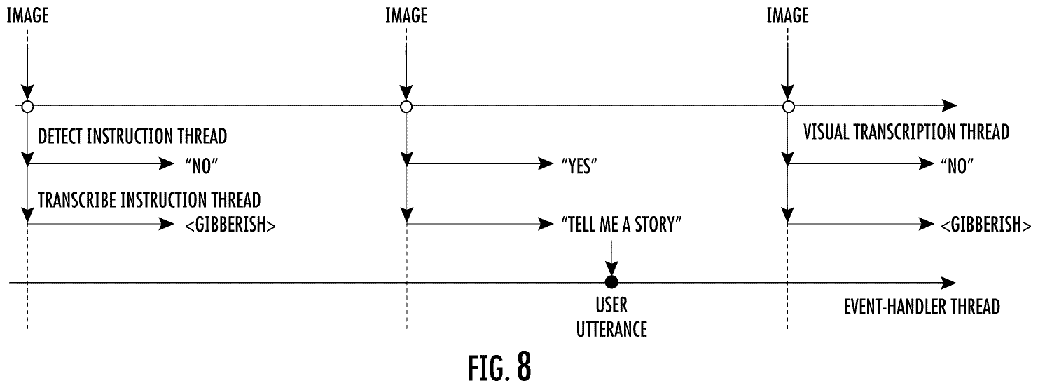

Referring now to FIG. 8, a schematic diagram illustrates an example interaction flow within a real-time multi-modal artificial intelligence agent, according to example implementations of aspects of the present disclosure. The diagram illustrates multiple threads: the detect instruction thread, the transcribe instruction thread, the visual transcription thread, and the event-handler thread.

Detect Instruction Thread: This thread can be responsible for analyzing incoming visual data to detect specific instructions or cues. As shown on the left side of the diagram, the detect instruction thread processes an image and determines that no relevant instruction is detected, outputting a “no” decision.

Transcribe Instruction Thread: Following the detect instruction thread, the transcribe instruction thread attempts to transcribe any detected instructions from the image. On the left side of the diagram, given the negative output from the previous thread, it outputs an indication of an unsuccessful transcription, due to the absence of clear instructions in the visual data.

However, at the center of the diagram, the detect instruction thread and the transcribe instruction thread operate to identify a user utterance, in which the user inputs “Tell me a story.”

Event-Handler Thread: This thread manages the responses and actions based on the outputs of other threads and the context of the interaction. For example, in response to the deleted and transcribed user utterance, the event-handler thread may initiate a new thread to generate a response to the user utterance.

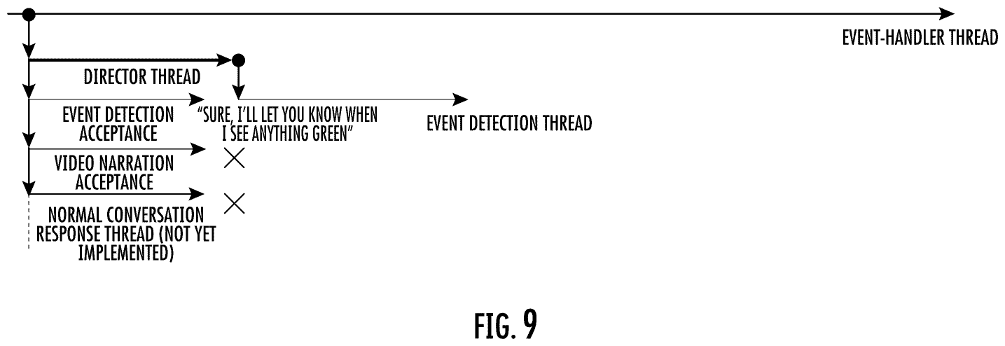

Referring now to FIG. 9, a schematic diagram is presented illustrating an example interaction flow within a real-time multi-modal artificial intelligence agent, according to example implementations of aspects of the present disclosure. Specifically, in the illustrated example, the director thread can serve as the central control unit, directing the flow of operations and interactions within the agent. It can manage the initiation and termination of other threads based on the requirements of the interaction or the user's commands.

### Example Methods

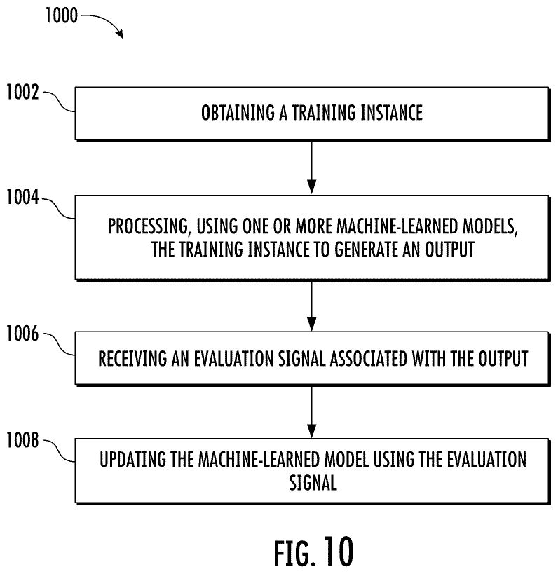

FIG. 10 depicts a flowchart of a method 1000 for training one or more machine-learned models according to aspects of the present disclosure. For instance, an example machine-learned model can include a sequence processing model.

One or more portion(s) of example method 1000 can be implemented by a computing system that includes one or more computing devices such as, for example, computing systems described with reference to the other figures. Each respective portion of example method 1000 can be performed by any (or any combination) of one or more computing devices. Moreover, one or more portion(s) of example method 1000 can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of example method 1000 can be performed additionally, or alternatively, by other systems.

At 1002, example method 1000 can include obtaining a training instance. A set of training data can include a plurality of training instances divided between multiple datasets (e.g., a training dataset, a validation dataset, or testing dataset). A training instance can be labeled or unlabeled. Although referred to in example method 1000 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1004, example method 1000 can include processing, using one or more machine-learned models, the training instance to generate an output. The output can be directly obtained from the one or more machine-learned models or can be a downstream result of a chain of processing operations that includes an output of the one or more machine-learned models.

At 1006, example method 1000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1008, example method 1000 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1000 can include implementing a number of generalization techniques (e.g., weight decays, dropouts, etc.) to improve the generalization capability of the models being trained.

In some implementations, example method 1000 can be implemented for training a machine-learned model from an initialized state to a fully trained state (e.g., when the model exhibits a desired performance profile, such as based on accuracy, precision, recall, etc.).

In some implementations, example method 1000 can be implemented for particular stages of a training procedure. For instance, in some implementations, example method 1000 can be implemented for pre-training a machine-learned model. Pre-training can include, for instance, large-scale training over potentially noisy data to achieve a broad base of performance levels across a variety of tasks/data types. In some implementations, example method 1000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

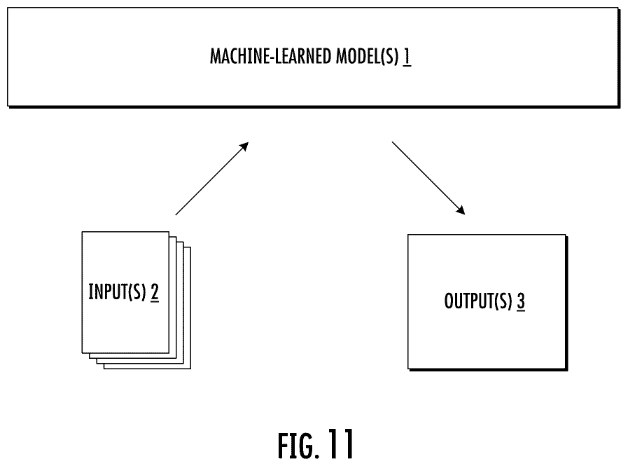

FIG. 11 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models. For example, the machine-learned models can be or include transformer models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

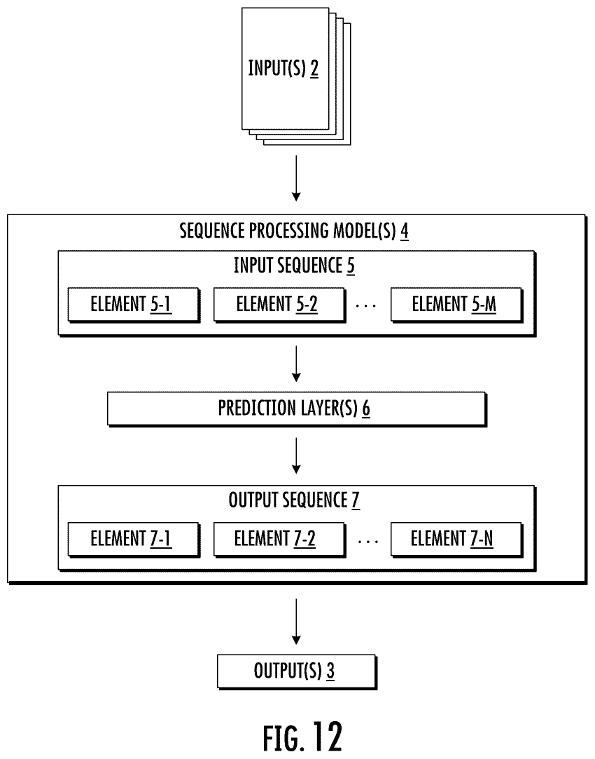

FIG. 12 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301. 11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image. Other tokenization approaches can be performed as well, including linear projections, non-linear transformations, and/or other data transformations.

In general, arbitrary data types can be serialized and processed into input sequence 5. It is to be understood that element(s) 5-1, 5-2, . . . , 5-M depicted in FIG. 12 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

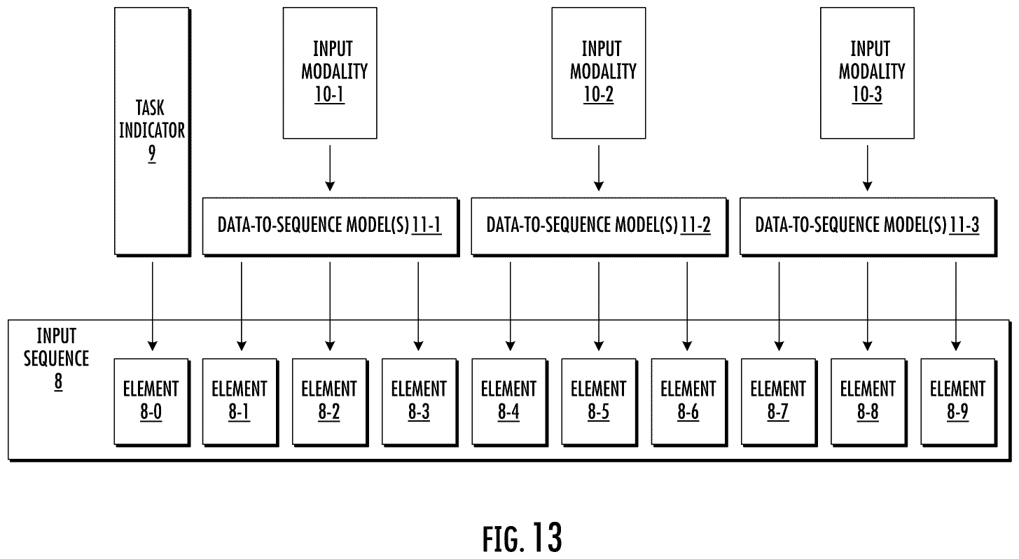

FIG. 13 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

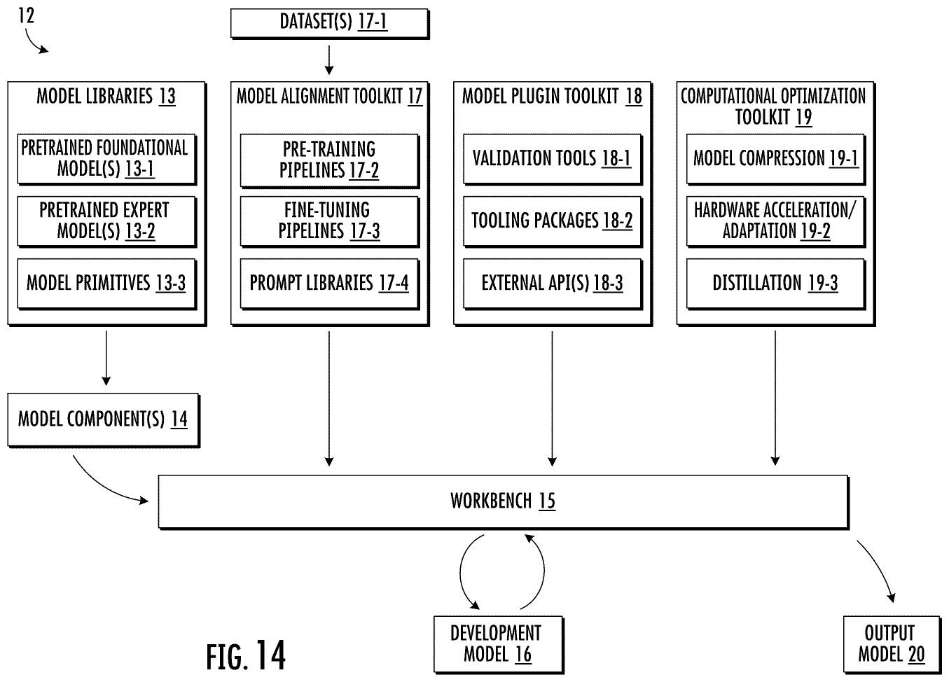

FIG. 14 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising,etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1000 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models-e.g., understanding an intent in an unstructured request for a task-while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

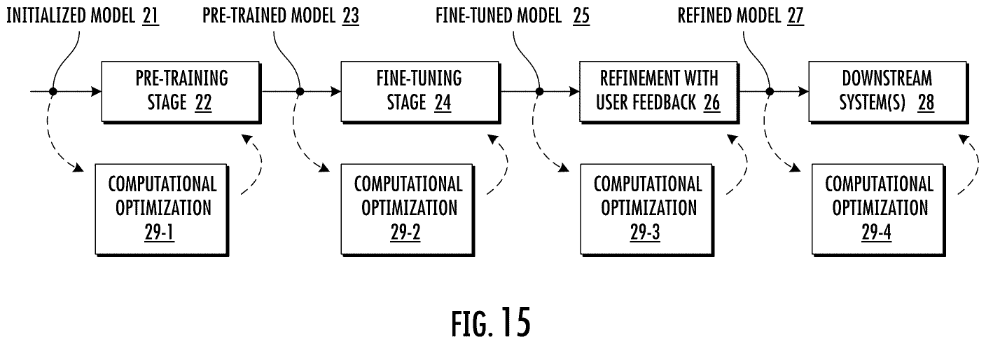

FIG. 15 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 15 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 15 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

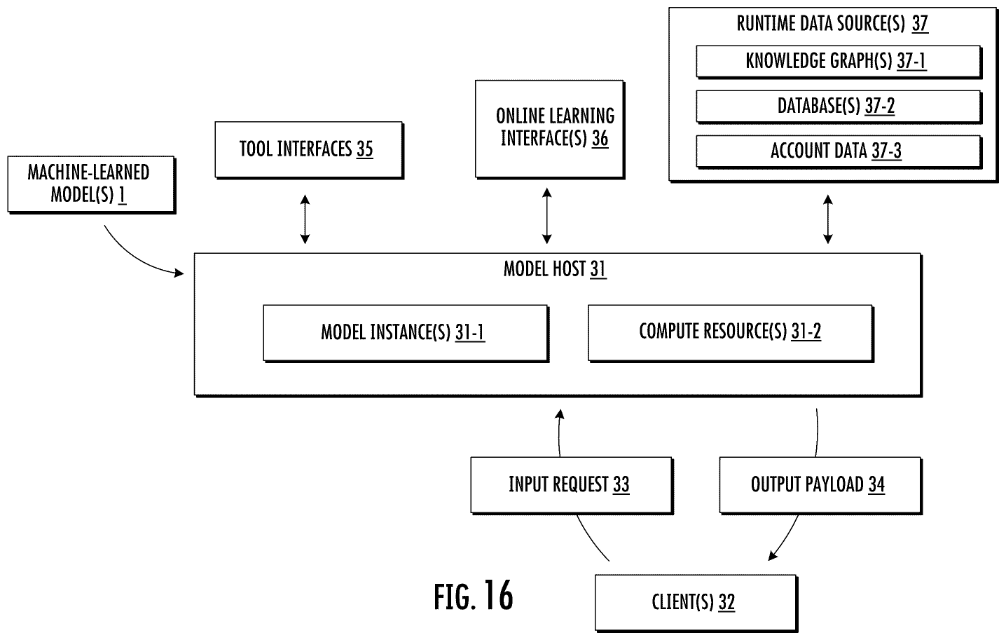

FIG. 16 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) I can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

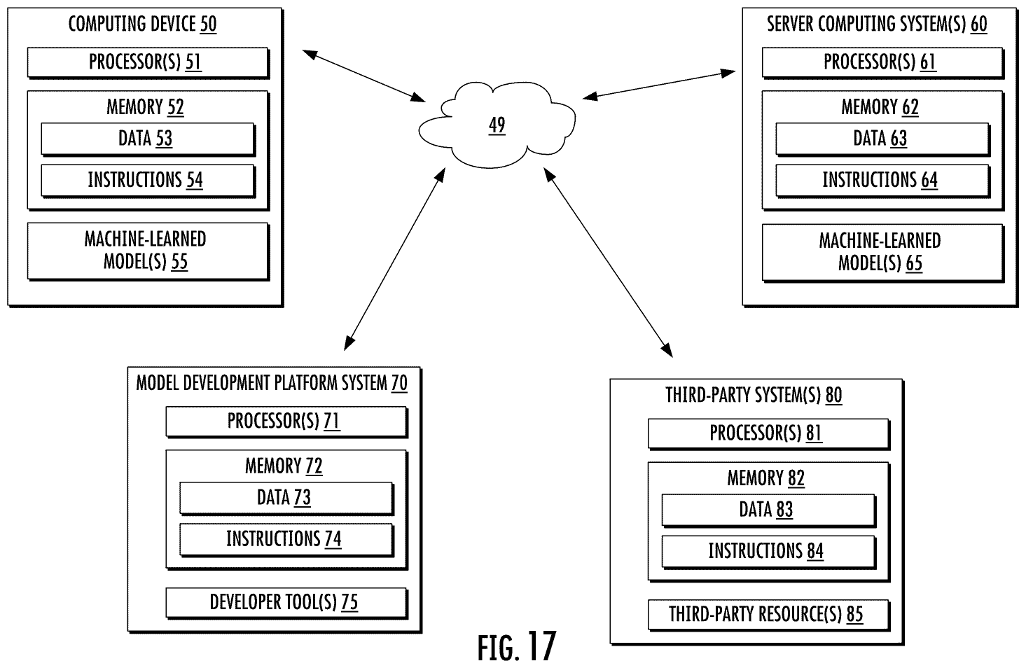

FIG. 17 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 17 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 17 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

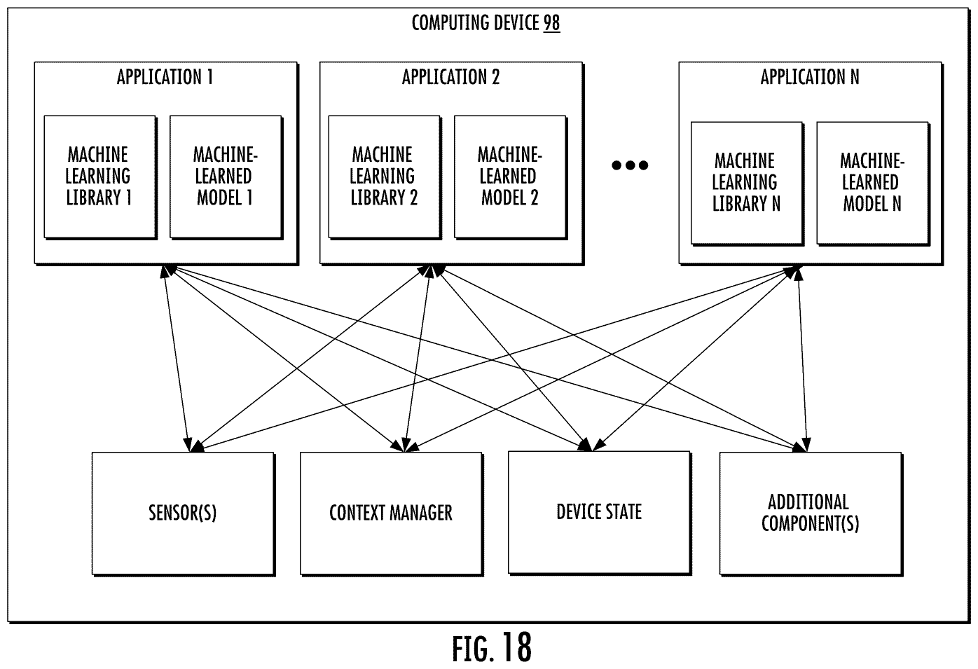

FIG. 18 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 18, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

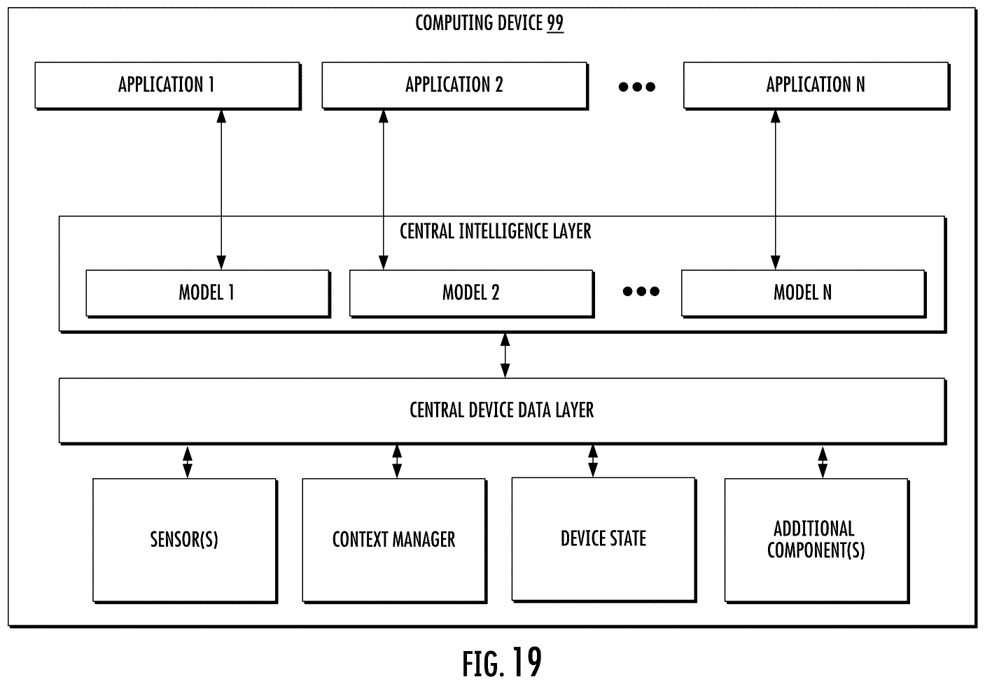

FIG. 19 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 19, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 19, the central device data layer can communicate with a number of other components of the computing device, such as, for example, one or more sensors, a context manager, a device state component, or additional components. In some implementations, the central device data layer can communicate with each device component using an API (e.g., a private API).

### Visualizations of Example Use Cases

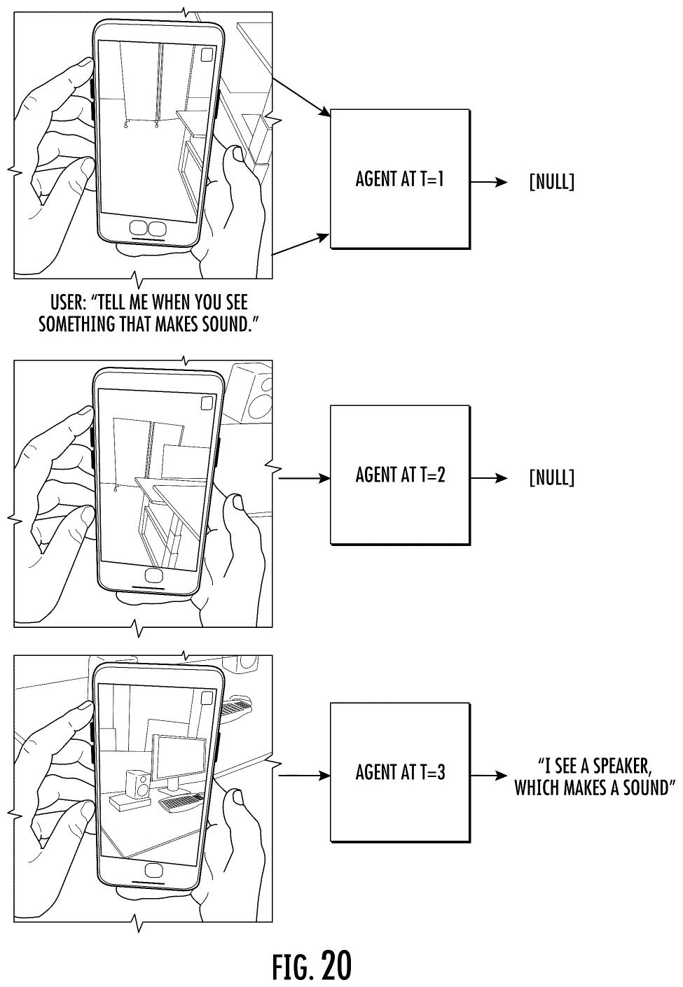

FIG. 20 illustrates a graphical diagram of an example artificial intelligence agent performing event detection in response to a user's request to identify objects that produce sound, according to example implementations of aspects of the present disclosure. At time t=1, the user instructs the agent, via a smartphone interface, to alert them upon detecting any object that makes sound. The first panel shows the agent's view through the smartphone camera at t=1, where no sound-producing objects are visible, leading the agent to output a null token, indicating no detection of relevant objects.

At time t=2, as depicted in the second panel, the agent continues to scan the environment through the smartphone's camera. Similar to the previous instance, no objects that produce sound are detected in the view, resulting in another null token output by the agent.

Finally, at time t=3, shown in the third panel, the agent identifies an audio speaker within its field of view. Recognizing the speaker as an object that produces sound, the agent successfully responds to the user's request by outputting the message “I see a speaker, which makes sound.” This indicates the agent's capability to detect and correctly identify sound-producing objects in real-time, fulfilling the user's specified task.

More particularly, in some implementations, at each of times 1, 2, and 3, the agent can provide the original query and the image received at that time as inputs to a multi-modal machine-learned model. The multi-modal machine-learned model may be a large foundational model, in which large amounts of knowledge about various topics has been encoded within the model parameters. At times t=1 and t=2, the output of the machine-learned model can be the null token, while at time t=3, the output of the multi-modal model may be the message described above. In some implementations, in response to the original query from the user, the agent can establish a dedicated thread that periodically (e.g., at each time t) queries the model with the newly-received imagery and the original query.

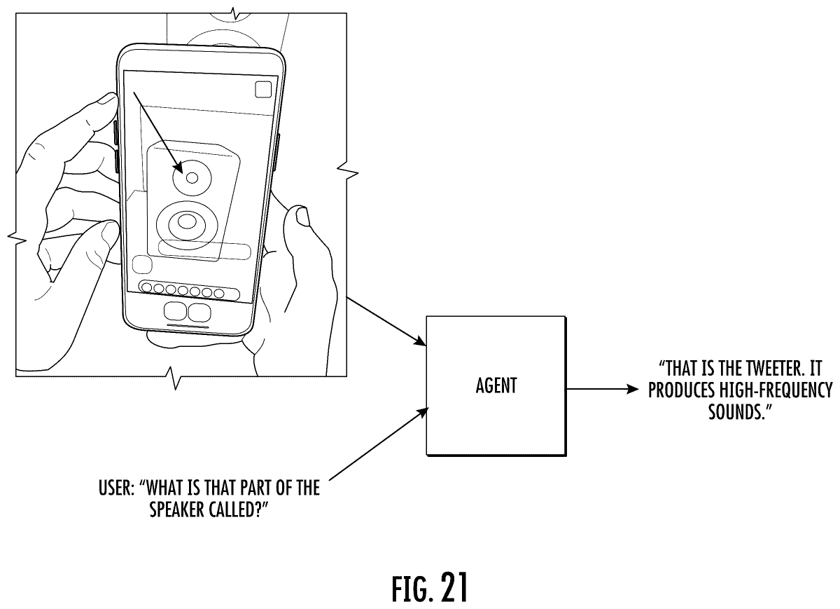

FIG. 21 presents a graphical diagram of an example artificial intelligence agent processing an input that includes visual data augmented with user input markup or annotations, according to example implementations of aspects of the present disclosure. In this scenario, the user queries the agent about a specific part of a speaker by asking, “What is that part of the speaker called?” To aid the agent in focusing on the relevant part of the speaker, the user draws an arrow on the smartphone screen pointing directly at the component in question.

The diagram shows the smartphone display capturing an image of a speaker, with the user's arrow overlaid on the image, pointing at a specific part of the speaker. This combined input, consisting of the visual data from the camera and the user's graphical markup (the arrow), is then processed by the agent. In particular, the agent can provide the combined input as an input for processing by a multi-modal machine-learned model. The multi-modal machine-learned model may be a large foundational model, in which large amounts of knowledge about various topics has been encoded within the model parameters.

Upon receiving and analyzing the augmented input, the agent utilizes its processing capabilities to identify the part of the speaker being indicated by the arrow. The agent successfully recognizes the component as a tweeter, which is known for producing high-frequency sounds. The agent then communicates this information back to the user, stating, “That is the tweeter. It produces high-frequency sounds.” More particularly, in some implementations, the agent can provide the user query and the modified imagery as an input to a multi-modal machine-learned model. In response, the machine-learned model can generate the response described above that identifies the tweeter.

This example illustrates the agent's ability to interpret combined inputs of visual data and user annotations to provide specific and contextually relevant information in response to user inquiries.

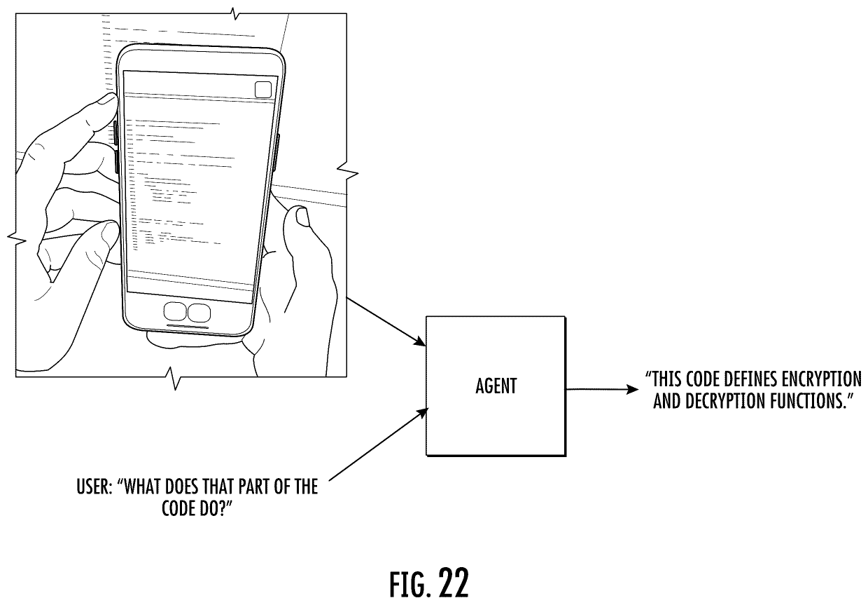

FIG. 22 illustrates a graphical diagram of an example artificial intelligence agent processing visual input that comprises visually-rendered computer code, according to example implementations of aspects of the present disclosure. In this instance, the user presents the agent with a query about a specific portion of computer code displayed on a smartphone screen by asking, “What does that part of the code do?”

The diagram shows the smartphone display capturing an image of the screen which contains lines of computer code. The user's query is directed towards understanding the functionality of a specific section of this code. The agent processes the visual input containing the computer code, analyzing the syntax and semantics of the code displayed on the screen.

Upon processing the input, the agent identifies the function of the highlighted code segment. The agent determines that the code defines encryption and decryption functions. Consequently, the agent communicates this information back to the user, stating, “This code defines encryption and decryption functions.”

This example demonstrates the agent's capability to interpret visually-rendered computer code from an image and provide precise information regarding the code's functionality in response to user inquiries. This ability highlights the agent's utility in educational and development settings where understanding code functionality directly from visual inputs can significantly enhance learning and debugging processes.

More particularly, in some implementations, the agent can provide the user query and the imagery of the screen as an input to a multi-modal machine-learned model. In response, the machine-learned model can generate the response described above that explains the code. The multi-modal machine-learned model may be a large foundational model, in which large amounts of knowledge about various topics has been encoded within the model parameters and which is capable of performing advanced analytical tasks.

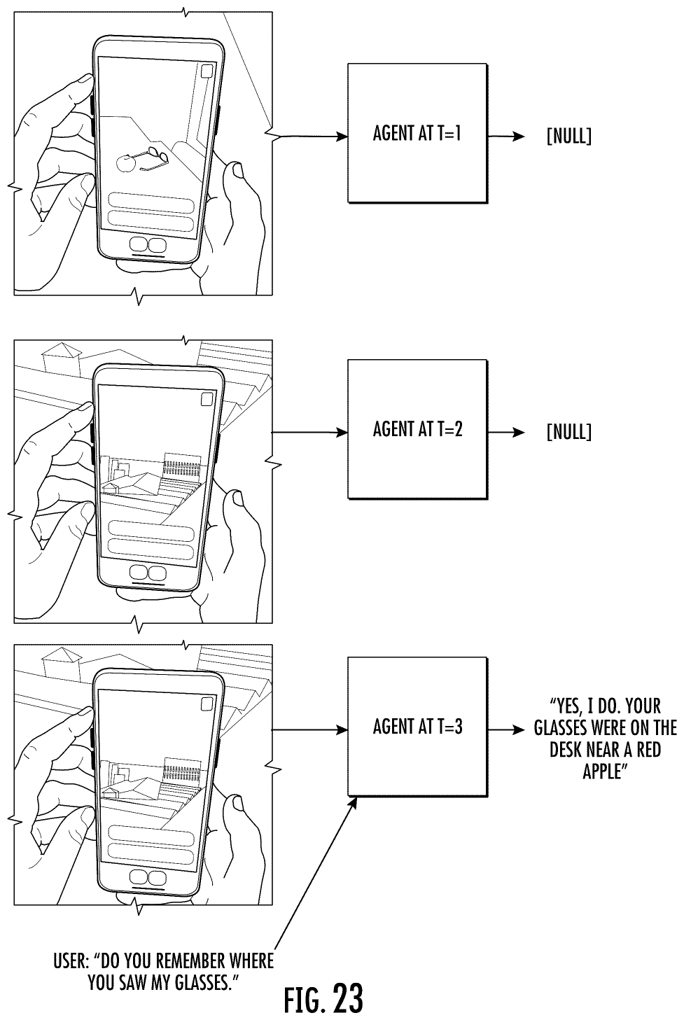

FIG. 23 depicts a graphical diagram of an example artificial intelligence agent performing information retrieval from prior observations, according to example implementations of aspects of the present disclosure. This scenario demonstrates the agent's ability to recall and utilize historical visual data in response to a user's query about the location of an object previously observed.

At time t=1, as shown in the first panel, the agent observes a desk scene through the smartphone's camera, which includes a pair of glasses and a red apple placed on the desk. The agent processes this scene but does not make any specific identification or action, resulting in a null output.

At time t=2, depicted in the second panel, the agent's view shifts to an outdoor scene visible through a window. Similar to the first observation, the agent processes the visual input but does not perform any specific action, leading to another null output.

At time t=3, shown in the third panel, the agent continues to view the outdoor scene. However, at this time, the user inputs a query to the agent, asking, “Do you remember where you saw my glasses?” This query prompts the agent to access its memory of prior observations. Leveraging its capability to recall and synthesize information from earlier visual data, the agent successfully identifies the location of the glasses as observed in the first panel.

The agent responds to the user's inquiry by stating, “Yes, I do. Your glasses were on the desk near a red apple,” accurately recalling the context and specifics of the initial observation where the glasses were located. This example illustrates the agent's advanced memory integration and retrieval capabilities, enabling it to provide useful information based on historical data in response to contextual inquiries from the user.

More particularly, in some implementations, the agent can provide the user query and a significant number of previously observed frames as an input to a multi-modal machine-learned model. In response, the machine-learned model can generate the response described above that identifies where the glasses were located. The multi-modal machine-learned model may be a large foundational model, which is capable of performing analysis over a large number of image frames. Alternatively or additionally, the agent may retrieve past image frames from a memory layer based matching previous object detections with objects identified in the user query (e.g., glasses). The agent may provide the retrieved image frames as an input to the machine-learned model which can then generate the response described above that identifies where the glasses were located.

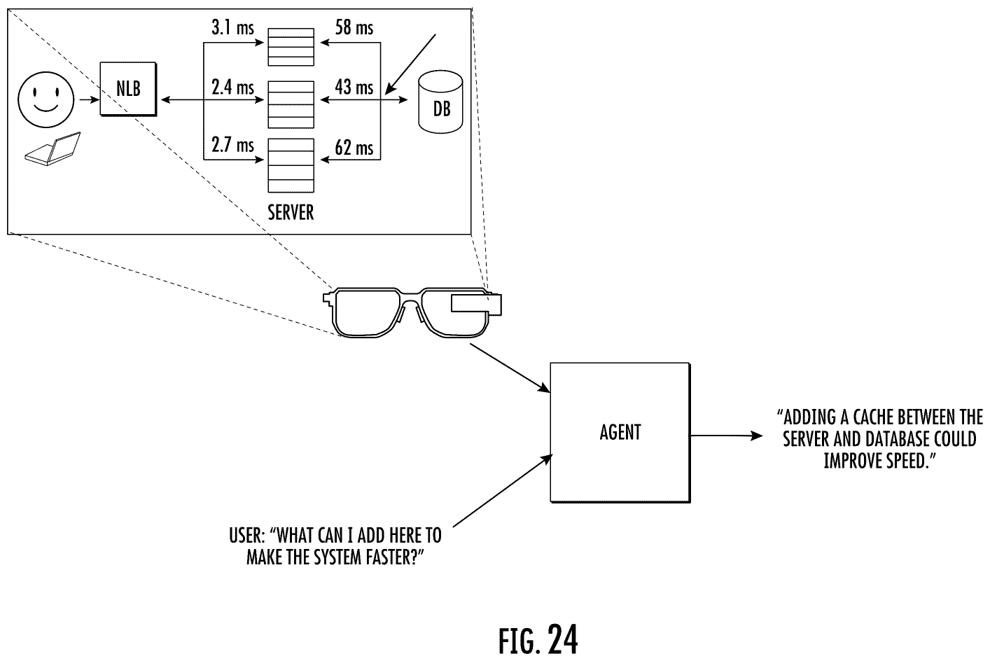

FIG. 24 illustrates a graphical diagram of an example artificial intelligence agent performing problem solving and system optimization, according to example implementations of aspects of the present disclosure. This scenario demonstrates the agent's capability to analyze system architecture and provide recommendations for improving performance based on user queries.

In this example, the user presents a query related to optimizing system performance by asking, “What can I add here to make the system faster?” The visual input provided to the agent includes a diagram of a server system architecture, which is displayed on a whiteboard and includes various components. The diagram also shows latency times between these components. The diagram also shows an arrow drawn by the user on the whiteboard that identifies a particular location in the diagram.

The agent processes this visual input along with the user's question. Based on its analysis, the agent suggests, “Adding a cache between the server and database could improve speed.” This example underscores the agent's ability to engage in complex problem-solving and provide actionable advice for system optimization, leveraging its foundational understanding of various specific topics in response to specific user inquiries.

More particularly, in some implementations, the agent can provide the user query and the imagery of the whiteboard as an input to a multi-modal machine-learned model. In response, the machine-learned model can generate the response described above that provides the suggested modification. The multi-modal machine-learned model may be a large foundational model, in which large amounts of knowledge about various topics has been encoded within the model parameters and which is capable of performing advanced analytical tasks.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computing system that implements an artificial intelligence agent, the computing system comprising:
one or more computing devices configured to receive and process input data to generate an agent action responsive to the input data, wherein the one or more computing devices comprise:
a tokenization server configured to tokenize the input data to generate a plurality of tokens; and
a model server that operates asynchronously with the tokenization server, the model server configured to receive the plurality of tokens from the tokenization server and the process the plurality of tokens with a machine-learned model to generate an output from the machine-learned model, wherein the agent action is based on the output from the machine-learned model.

2. The computing system of claim 1, wherein the input data comprises video data and the plurality of tokens comprise video tokens.

3. The computing system of claim 1, wherein the computing system receives the input data via a real-time communications framework.

4. The computing system of claim 3, wherein the real-time communications framework comprises a Web Real-Time Communication framework.

5. The computing system of claim 1, wherein the tokenization server transfers the plurality of tokens to the model server via bidirectional input streaming.

6. The computing system of claim 1, wherein the input data comprises data corresponding to a plurality of modalities, and wherein the tokenization server separately tokenizes the input data for each of the plurality of modalities to generate a plurality of sets of tokens respectively associated with the plurality of modalities.

7. The computing system of claim 6, wherein the tokenization server assembles the plurality of sets of tokens into a temporally-ordered token history.

8. The computing system of claim 7, wherein the tokenization server streams the temporally-consistent token history to the model server.

9. The computing system of claim 1, wherein the machine-learned model comprises a sequence processing model that has been finetuned on real-world dialogue data.

10. The computing system of claim 1, wherein the input data comprises a combination of video data and transcribed speech data.

11. The computing system of claim 1, wherein, for at least one model inference, the output from the machine-learned model comprises a NULL token.

12. The computing system of claim 1, wherein the multi-modal agent comprises a situated agent, and wherein at least a portion of the input data comprises data descriptive of an environment that is observable by a human user of the situated agent.

13. The computing system of claim 1, wherein the output of the machine-learned model comprises an event detection output.

14. The computing system of claim 1, wherein the computing system implements one or more chain of prompts to perform instruction retrieval, visual extraction, response moderation, or state tracking.

15. The computing system of claim 1, wherein the computing system implements the artificial intelligence agent with multiple parallel computational threads.

16. The computing system of claim 1, wherein the multiple parallel computational threads comprise a base response thread and an ad hoc event detection thread, wherein the computing system initiates the ad hoc event detection thread in response to a user query.

17. The computing system of claim 1, further comprising:
a memory layer that is communicatively coupled to the model server, wherein the memory layer stores data associated with previously-received input data that was received at one or more past times, and wherein data retrieved from the memory layer is provided as contextual input to machine-learned model.

18. The computing system of claim 17, wherein the data retrieved from the memory layer comprises object detection data, embedding data, or tokenized input data.

19. The computing system of claim 1, wherein the input data comprises augmented visual data, the augmented visual data comprising visual data that has been augmented with one or more user annotations or markups.

20. A computer-implemented method for providing an artificial intelligence agent, the method comprising:
obtaining, by a computing system comprising one or more computing devices, input data;
tokenizing, by a tokenization server of the computing system, the input data to generate a plurality of tokens;
streaming, by the tokenization server, the plurality of tokens to a model server of the computing system, the model server operating asynchronously with the tokenization server;
processing, by the model server, the plurality of tokens with a machine-learned model to generate an output from the machine-learned model; and
performing, by the computing system, an agent action based at least in part on the output from the machine-learned model.

21. The computer-implemented method of claim 20, wherein obtaining the input data comprises receiving the video data via a real-time communications framework, and wherein the plurality of tokens comprise video tokens.

22. The computer-implemented method of claim 20, wherein streaming, by the tokenization server, the plurality of tokens to the model server comprises performing bidirectional input streaming.

23. The computer-implemented method of claim 20, wherein:
the input data comprises data corresponding to a plurality of modalities;
tokenizing, by the tokenization server of the computing system, the input data to generate the plurality of tokens comprises separately tokenizing, by the tokenization server, the input data for each of the plurality of modalities to generate a plurality of sets of tokens respectively associated with the plurality of modalities;
the method further comprises assembling, by the tokenization server, the plurality of sets of tokens into a temporally-ordered token history; and
streaming, by the tokenization server, the plurality of tokens to the model server comprises streaming, by the tokenization server, the temporally-ordered token history to the model server.

24. One or more non-transitory computer-readable media storing computer-executable instructions for performing operations, the operations comprising:
receiving, by a model server and from a tokenization server, a data stream comprising a plurality of tokens, wherein the plurality of tokens were generated by the tokenization server from input data, and wherein the tokenization server operates asynchronously from the model server;
processing, by the model server, the plurality of tokens with a machine-learned model to generate an output from the machine-learned model; and
providing, by the model server, the output from the machine-learned model to a computing system to generate an agent action based at least in part on the output from the machine-learned model.
